(19) United States
(12) Patent Application Publication
(10) Pub. No.: US 2007/0003679 A1
(43) Pub. Date: Jan. 4, 2007

(54) Sweetener comprising a stevia-derived sweet substance

(75) Inventors: Takehiro Shimizu, Tokyo (JP); Mitsutoshi Tatara, Tokyo (JP); Toshihito Shimizu, Tokyo (JP)

Correspondence Address: Norris, McLaughlin & Marcus P.A., 18th Floor, 875 Third Avenue, New York, NY, 10022, US

(73) Assignee: Sato Pharmaceutical Co., Ltd., Tokyo (JP)

(21) Appl. No.: 11/364,995

(22) Filed: Mar. 1, 2006

(30) Foreign Application Priority Data
Mar. 4, 2005 (JP) 2005-061138

(51) Int. Cl. A23L 1/236

(52) U.S. Cl. 426/548

(57) ABSTRACT

A sweetener containing a Stevia-derived sweet substance is provided that, while containing cyclodextrin only in small amounts, can mask the bitter taste inherent in the Stevia-derived sweet substance.

Cyclodextrin with a particle size of less than or equal to 30 μm is blended into the Stevia-derived sweet substance at 0.5 to 20 mass % with respect to the mass of the Stevia-derived sweet substance.

### BACKGROUND OF THE INVENTION

1. Field of the Invention

The present invention relates to a sweetener that contains a Stevia-derived sweet substance.

2. Description of the Related Art

The Stevia-derived sweet substances present in the Stevia plant are from about 50 to 450 times sweeter than sugar. Since these intensely sweet Stevia-derived sweet substances can be used in amounts from about 1/50th to 1/450th that of sugar, they can provide a significant reduction in caloric intake. This fact, with the increased consumer consciousness with regard to health and beauty, has resulted in attention on Stevia-derived sweet substances as sugar-substitute sweeteners.

Stevia-derived sweet substances, however, have a characteristically bitter taste that is not present in sugar. The most significant issue for the use of Stevia-derived sweet substances as sweeteners is the masking of this bitter taste.

The art of using cyclodextrins, which have the capacity to incorporate other substances, is known within the sphere of attempts at masking the bitter taste that is inherent in Stevia-derived sweet substances (refer, for example, to Japanese Patent Application Laid-open Numbers 57-150358, 60-98957, and 60-188035).

The art disclosed in these references in each case uses a high proportion of cyclodextrin relative to the mass of the stevioside (Japanese Patent Application Laid-open Numbers 57-150358 and 60-98957 teach an amount that is at least equal to the mass of the Stevia-derived sweet substance. Japanese Patent Application Laid-open No. 60-188035 teaches at least 50 mass % relative to the mass of the Stevia-derived sweet substance).

However, cyclodextrin exhibits a high hygroscopicity, and when blended in foods in large amounts causes the food itself to take on a high hygroscopicity. A container that has the ability to prevent moisture absorption then becomes necessary in order to prevent moisture absorption-induced deterioration of the food, which as a consequence creates the problem of driving up production costs.

In addition, when cyclodextrin is introduced in large amounts into a food, not only the bitter components of the Stevia-derived sweet substance, but also even the aroma components inherent in the food itself end up being incorporated by the cyclodextrin, causing the additional problem of a loss of taste by the food.

Moreover, the risk of cyclodextrin ingested in large amounts incorporating toxic substances that are not naturally absorbed within the body and inducing their absorption in the body has been very recently pointed out. This has led to the regulation of cyclodextrin use levels in the United States. From this perspective also, the admixture of large amounts of cyclodextrin in a Stevia-derived sweet substance should be avoided.

On the other hand, cyclodextrin is a poorly water-soluble substance. As a consequence, when a sweetener comprising a Stevia-derived sweet substance and cyclodextrin is used in a high water content food (for example, coffee) and particularly in a cold high water content food, the admixture of small amounts of cyclodextrin results in an inadequate manifestation of the bitter taste masking activity. Increasing the amount of cyclodextrin addition to solve this problem then produces the problems described above that are associated with the use of large amounts of cyclodextrin.

### SUMMARY OF THE INVENTION

Accordingly, an object of the present invention is to provide a sweetener containing a Stevia-derived sweet substance that, while containing only small amounts of cyclodextrin, can nevertheless mask the bitter taste inherent in a Stevia-derived sweet substance.

The present inventors carried out intensive and extensive investigations in order to solve the problems identified hereinabove and as a result discovered that the bitter taste inherent in a Stevia-derived sweet substance can be masked by the admixture of small amounts of cyclodextrin when cyclodextrin that has been pulverized to a specific average particle size is admixed in specific proportions relative to the Stevia-derived sweet substance. This invention was achieved based on this knowledge.

In specific terms, the present invention relates to a sweetener comprising a Stevia-derived sweet substance and from 0.5 to 20 mass %, with respect to the mass of the Stevia-derived sweet substance, cyclodextrin with an average particle size of less than or equal to 30 μm.

As shown in the examples provided below, the sweetener according to the present invention has the ability to mask the bitter taste inherent in a Stevia-derived sweet substance, even though the sweetener contains only a small amount of the cyclodextrin. Therefore, the sweetener of the present invention can be advantageously used as a sugar-substitute sweetener.

### DETAILED DESCRIPTION OF THE INVENTION

The invention is described in detail hereinbelow.

The sweetener according to the present invention characteristically comprises a Stevia-derived sweet substance and from 0.5 to 20 mass %, with respect to the mass of the Stevia-derived sweet substance, cyclodextrin with an average particle size of less than or equal to 30 μm.

“Stevia-derived sweet substance” denotes the sweet substances present in Stevia (Stevia rebaudiana Bertoni), which is a plant in the Stevia genus of the family Compositae. Stevia-derived sweet substances are known to have a sweetness from about 50 to 450 times that of sugar. Specific examples are stevioside, rebaudioside A, rebaudioside C, rebaudioside D, rebaudioside E, and dulcoside A. Rebaudioside A is most preferred among these from the standpoint of flavor quality.

The sweetener according to the present invention can use a single Stevia-derived sweet substance or can use a combination of two or more Stevia-derived sweet substances.

Stevia-derived sweet substances are known substances and can be readily acquired commercially, or they can be purified from Stevia, for example, according to the method described in Japanese Patent 3,436,317.

The Stevia-derived sweet substance is preferably subjected to enzymatic treatment from the standpoint of improving the flavor quality.

The enzyme used in this treatment can be exemplified by glucoamylase, α-glucosidase, and so forth.

The enzymatic treatment can be carried out, for example, according to the method described in Japanese Patent Publication Number 57-18779 (Japanese Patent 1,169,566).

“Cyclodextrin” refers to a molecule in which from 6 to 8 D-glucose molecules form a cyclic structure by α 1→4 bonds. It is known that cyclodextrin can incorporate other substances in this structure. Specific examples are α-cyclodextrin (formed from 6 glucose molecules), β-cyclodextrin (formed from 7 glucose molecules), and γ-cyclodextrin (formed from 8 glucose molecules).

The sweetener according to the present invention can use a single cyclodextrin or can use a combination of two or more cyclodextrins.

Cyclodextrin is a known substance and can be readily acquired commercially, or it can be produced by the enzymatic treatment of starch, for example, according to the method described in Japanese Patent Application Laid-open No. 05-244945.

The cyclodextrin used by the present invention has an average particle size of less than or equal to 30 μm, preferably less than or equal to 10 μm, and particularly preferably less than or equal to 5 μm.

The average particle size of cyclodextrin can be measured using an instrument for measuring particle size distributions that employs the measurement principle of laser diffraction scattering. For example, measurement can be carried out by a wet method using a laser diffraction/scattering instrument for measuring particle size distributions (product name: HORIBA LA910, source: Horiba Ltd.).

When the average particle size is less than or equal to 30 μm, the bitter taste inherent in a Stevia-derived sweet substance can be masked even at low levels of addition (that is, 0.5 to 20 mass % with respect to the mass of the Stevia-derived sweet substance).

The aforementioned commercially available cyclodextrin and the cyclodextrin produced by the enzymatic treatment of starch ordinarily have an average particle size of from 50 to 500 μm. In such cases, the cyclodextrin must be pulverized in order for it to be used by the present invention. The cyclodextrin can be pulverized using those pulverizing means ordinarily used in the field of the concerned art, for example, a jet mill, ball mill, automatic mortar, oscillator, conical mill, hammer mill, atomizer, and so forth. Among these, the jet mill is particularly preferred for its ability to carry out pulverizing efficiently without generating heat during pulverizing.

The cyclodextrin is blended in the sweetener according to the present invention at from 0.5 to 20 mass %, preferably 0.5 to 10 mass %, and particularly preferably 0.5 to 5 mass %, in each case with respect to the mass of the Stevia-derived sweet substance. When the cyclodextrin is admixed at 0.5 to 20 mass % with respect to the mass of the Stevia-derived sweet substance, the bitter taste of the Stevia-derived sweet substance can be masked without impairing the flavor inherent in the food to which the sweetener has been added.

Without limiting the present invention to a particular theory, it is thought that the bitter taste of a Stevia-derived sweet substance can be masked by the sweetener according to the present invention, which contains a small amount of cyclodextrin at 0.5 to 20 mass % with respect to the mass of the Stevia-derived sweet substance, through an increase in the water solubility of cyclodextrin brought about by the pulverizing of the cyclodextrin to an average particle size of less than or equal to 30 μm (Cyclodextrin has a structure that presents a hydrophilic exterior and a hydrophobic interior. As a result, hydrophobic substances (bitter substances in the Stevia-derived sweet substance) can be incorporated therein in the presence of water (after addition of the sweetener to food or after introduction into the mouth). Accordingly, an increase in the water solubility of cyclodextrin enables the masking of more bitter substance.).

Furthermore, the fact that the sweetener according to the present invention does not impair the flavor of food containing this sweetener is believed to be due to the inclusion activity of small amounts of cyclodextrin, i.e., 0.5 to 20 mass % with respect to the mass of the Stevia-derived sweet substance, extending exclusively to bitter components in the Stevia-derived sweet substance and not to aroma components inherent in the food.

The sweetener according to the present invention can be prepared by mixing or kneading the Stevia-derived sweet substance with the pulverized cyclodextrin.

Those mixing means generally used in the field of the concerned art can be used for this purpose without particular limitation.

In order to obtain uniform blending between the Stevia-derived sweet substance and pulverized cyclodextrin in the sweetener, the Stevia-derived sweet substance and pulverized cyclodextrin are preferably kneaded with each other in the presence of a wetting agent and the resulting mixture is then dried.

Water and ethanol are preferred for the wetting agent from the standpoint of safety. A single wetting agent or a combination of two or more wetting agents (for example, a water and ethanol mixture) can be used.

Those kneading means generally used in the field of the concerned art can be used for this purpose without particular limitation.

Those drying means generally used in the field of the concerned art can be used here without particular limitation.

The sweetener according to the present invention may contain a suitable sweet substance in addition to the Stevia-derived sweet substance. This sweet substance other than the Stevia-derived sweet substance can be exemplified by sugar, glucose, fructose, maltitol, xylitol, and erythritol.

The sweetener according to the present invention can use a single such other sweet substance or a combination of two or more of such other sweet substances.

The sweetener according to the present invention can be used as a sugar-substitute sweetener in, for example, foods, luxury goods, food additives, and drugs. Among these, the sweetener according to the present invention is very suitably used in high water content foods (for example, beverages such as coffee and tea, yogurt, and citrus fruits) and in particular in cold high water content foods.

The present invention is specifically described by the examples provided below, but is not limited by the examples.

### EXAMPLES

### Production Example 1

Using a ball mill (product name: pot mill, source: Nihon Kagaku Togyo Kabushiki Kaisha), 100 g of β-cyclodextrin (product name: Celdex (registered trademark) B-100, source: Nihon Shokuhin Kako Co., Ltd.) was pulverized for 30 minutes at 50 rpm. The resulting pulverized cyclodextrin had an average particle size of 30 μm as measured by a wet method using a laser diffraction/scattering instrument for measuring particle size distributions (HORIBA LA910).

### Production Example 2

Using a jet mill (product name: CO-JET System α-mkIII, source: Seishin Enterprise Co., Ltd.), 100 g of β-cyclodextrin (product name: Celdex (registered trademark) B-100z, source: Nihon Shokuhin Kako Co., Ltd.) was pulverized at push nozzle: 0.6 MPa and gliding nozzle: 0.5 MPa. The resulting pulverized cyclodextrin had an average particle size of 2.4 μm as measured by a wet method using a laser diffraction/scattering instrument for measuring particle size distributions (HORIBA LA910).

### Production Example 3

Using γ-cyclodextrin (product name: Celdex (registered trademark) G-100, source: Nihon Shokuhin Kako Co., Ltd.) as the cyclodextrin, γ-cyclodextrin was pulverized by a procedure that was otherwise the same as in Production Example 2 to obtain γ-cyclodextrin with an average particle size of 2.4 μm.

### Production Example 4

Using α-cyclodextrin (product name: Celdex (registered trademark) A-100, source: Nihon Shokuhin Kako Co., Ltd.) as the cyclodextrin, γ-cyclodextrin was pulverized by a procedure that was otherwise the same as in Production Example 2 to obtain γ-cyclodextrin with an average particle size of 2.4 μm.

### Production Example 5

β-cyclodextrin was used as acquired without pulverizing (product name: Celdex (registered trademark) B-100, source: Nihon Shokuhin Kako Co., Ltd.). This cyclodextrin had an average particle size of 100 μm as measured by a wet method using a laser diffraction/scattering instrument for measuring particle size distributions (HORIBA LA910).

### Production Example 6

An enzymatically treated Stevia-derived sweet substance (product name: (αGSweetPX, source: Toyo Sugar Refining Co., Ltd.) was acquired as the Stevia-derived sweet substance.

### Example 1

A sweetener containing a Stevia-derived sweet substance was obtained by mixing 1 mass part of the β-cyclodextrin (average particle size=30 μm) of Production Example 1 and 5 mass parts of the enzymatically treated Stevia-derived sweet substance of Production Example 6 for 3 minutes using a vertical granulator VG-1 (product of Powrex Corporation) and conditions of blade: 400 rpm and cross screw: 400 rpm.

The content of the pulverized cyclodextrin in the Stevia-derived sweet substance-containing sweetener of this example was 20 mass % with respect to the mass of the Stevia-derived sweet substance.

### Example 2

A sweetener containing a Stevia-derived sweet substance was obtained according to the procedure described in Example 1, but in this case using 0.025 mass part (0.5 mass % with respect to the mass of the Stevia-derived sweet substance) of the γ-cyclodextrin (average particle size=30 μm) of Production Example 1 as the cyclodextrin.

### Example 3

Using a vertical granulator VG-1 (product of Powrex Corporation), 0.1 mass part of the β-cyclodextrin (average particle size=2.4 μm) of Production Example 2, 5 mass parts of the enzymatically treated Stevia-derived sweet substance of Production Example 6, and 94.9 mass parts of sugar as an optional component (product name: Granuto GFH, source: Mitsui Sugar Co., Ltd.) were intermixed along with 1.2 weight parts ethanol. This was followed by drying to give sweetener containing a Stevia-derived sweet substance.

The content of the pulverized cyclodextrin in the Stevia-derived sweet substance-containing sweetener of this example was 2 mass % with respect to the mass of the Stevia-derived sweet substance.

### Example 4

A sweetener containing a Stevia-derived sweet substance was obtained according to the procedure described in Example 3, but in this case using 0.1 mass part (2 mass % with respect to the mass of the Stevia-derived sweet substance) of the γ-cyclodextrin (average particle size=2.4 μm) of Production Example 3 as the pulverized cyclodextrin.

### Example 5

A sweetener containing a Stevia-derived sweet substance was obtained by mixing 0.17 mass part of the α-cyclodextrin (average particle size=2.4 μm) of Production Example 4, 16.7 mass parts of the enzymatically treated Stevia-derived sweet substance of Production Example 6, and 383.13 mass parts of sugar as an optional component (product name: Granuto GFH, source: Mitsui Sugar Co., Ltd.) using a vertical granulator VG-1 (product of Powrex Corporation).

The content of the pulverized cyclodextrin in the Stevia-derived sweet substance-containing sweetener of this example was 1.02 mass % with respect to the mass of the Stevia-derived sweet substance.

### Example 6

A sweetener containing a Stevia-derived sweet substance was obtained according to the procedure described in Example 5, but in this case using 0.17 mass part (1.02 mass % with respect to the mass of the Stevia-derived sweet substance) of the γ-cyclodextrin (average particle size=2.4 μm) of Production Example 3 as the pulverized cyclodextrin.

### Comparative Example 1

A sweetener containing a Stevia-derived sweet substance was obtained by mixing 1 mass part of the β-cyclodextrin (average particle size=100 μm) of Production Example 5 and 5 mass parts of the enzymatically treated Stevia-derived sweet substance of Production Example 6 for 3 minutes using a vertical granulator VG-1 (product of Powrex Corporation) and conditions of blade: 400 rpm and cross screw: 400 rpm.

The content of the pulverized cyclodextrin in the Stevia-derived sweet substance-containing sweetener of this example was 20 mass % with respect to the mass of the Stevia-derived sweet substance.

### Comparative Example 2

A sweetener containing a Stevia-derived sweet substance was obtained according to the procedure described in Comparative Example 1, but in this case using 2 mass parts (40 mass % with respect to the mass of the Stevia-derived sweet substance) of the β-cyclodextrin (average particle size=30 μm) of Production Example 1 as the cyclodextrin.

### Comparative Example 3

A sweetener containing a Stevia-derived sweet substance was obtained according to the procedure described in Comparative Example 1, but in this case using 0.005 mass part (0.1 mass % with respect to the mass of the Stevia-derived sweet substance) of the β-cyclodextrin (average particle size=30 μm) of Production Example 1 as the cyclodextrin.

The composition of each of the Stevia-derived sweet substance-containing sweeteners of Examples 1 to 5 and Comparative Examples 1 to 3 is shown in Table 1 below. The numerical values for each component in the table indicate mass parts.

TABLE 1

| | | | | | | | Comp. | Comp. | Comp. |
|---|---|---|---|---|---|---|---|---|---|
| A | Ex. 1 | Ex. 2 | Ex. 3 | Ex. 4 | Ex. 5 | Ex. 6 | Ex. 1 | Ex. 2 | Ex. 3 |
| B | 5 | 5 | 5 | 5 | 16.7 | 16.7 | 5 | 5 | 5 |
| C | — | — | 0.1 | — | | — | — | — | — |
| D | 1 | 0.025 | — | — | | — | — | 2 | 0.005 |
| E | — | — | — | — | | — | 1 | — | — |
| F | — | — | — | 0.1 | | 0.17 | — | — | — |
| G | | | | | 0.17 | | | | |
| H | — | — | 94.9 | 94.9 | 383.13 | 383.13 | — | — | — |

keys to the leftmost column in the table:
A: component name
B: Stevia-derived sweet substance
C: β-cyclodextrin (average particle size: 2.4 μm)
D: β-cyclodextrin (average particle size: 30 μm)
E: β-cyclodextrin (average particle size: 100 μm)
F: γ-cyclodextrin (average particle size: 2.4 μm)
G: α-cyclodextrin (average particle size: 2.4 μm)
H: sugar

Test Examples

Sensory evaluation was carried out on the Stevia-derived sweet substance-containing sweeteners of Examples 1 to 4 and Comparative Examples 1 to 3. Specifically, sensory evaluation was carried out with respect to
(1) the bitter taste inherent in a Stevia-derived sweet substance and

(2) the coffee flavor on coffee prepared by adding one of the sweeteners in the amount shown in Table 2 to 200 mL coffee (coffee temperature: about 65 to 70° C.). The evaluation of the coffee flavor (2) was carried out in order to evaluate whether a loss of coffee flavor had occurred due to the inclusion by the cyclodextrin of the aroma components of the coffee.

TABLE 2

| | | | | | Comp. | Comp. | Comp. |
|---|---|---|---|---|---|---|---|
| A | Ex. 1 | Ex. 2 | Ex. 3 | Ex. 4 | Ex. 1 | Ex. 2 | Ex. 3 |
| B | 0.33 g | 0.33 g | 0.35 g | 0.35 g | 0.33 g | 0.33 g | 0.33 g |

keys to the table:
A: component name
B: amount of sweetener addition

(1) Sensory Evaluation of the Bitter Taste Inherent in a Stevia-derived Sweet Substance

Sensory evaluation was carried out in this case by an evaluation panel of 20 individuals using “the bitter taste inherent in a Stevia-derived sweet substance is detected” or “the bitter taste inherent in a Stevia-derived sweet substance is not detected” as the evaluation standard.

The results are shown in Table 3.

TABLE 3

| | | | | | Comp. | Comp. | Comp. |
|---|---|---|---|---|---|---|---|
| | Ex. 1 | Ex. 2 | Ex. 3 | Ex. 4 | Ex. 1 | Ex. 2 | Ex. 3 |
| A | 3 | 7 | 1 | 2 | 16 | 2 | 19 |
| B | 17 | 13 | 19 | 18 | 4 | 18 | 1 |

keys to the table:
A: number of individuals reporting bitter taste
B: number of individuals not reporting bitter taste

(2) Sensory Evaluation of the Coffee Flavor

This sensory evaluation was carried out by an evaluation panel of 10 individuals using “good flavor” or “poor flavor” as the evaluation standard.

The results are shown in Table 4.

TABLE 4

| | | | | | Comp. | Comp. | Comp. |
|---|---|---|---|---|---|---|---|
| | Ex. 1 | Ex. 2 | Ex. 3 | Ex. 4 | Ex. 1 | Ex. 2 | Ex. 3 |
| A | 7 | 9 | 8 | 8 | 6 | 2 | 10 |
| B | 3 | 1 | 2 | 2 | 4 | 8 | 0 |

keys to the table:
A: number of individuals reporting good flavor
B: number of individuals reporting poor flavor

The relationship between the preceding sensory evaluations and the average particle size of the cyclodextrin and its quantity of addition is shown in Table 5.

The evaluation of the “bitter taste inherent in a Stevia-derived sweet substance” and the evaluation of “coffee flavor” are shown in Table 5 according to the following rules. bitterness ◯: sample for which the majority of individuals rendered the evaluation “the bitter taste inherent in a Stevia-derived sweet substance is not detected” bitterness x : sample for which the majority of individuals rendered the evaluation “the bitter taste inherent in a Stevia-derived sweet substance is detected” flavor ◯: sample for which the majority of individuals rendered the evaluation “good coffee flavor” flavor x : sample for which the majority of individuals rendered the evaluation “poor coffee flavor”

TABLE 5

| | | average particle size of the | | |
|---|---|---|---|---|
| | | cyclodextrin | | |
| | | 100 μm | 30 μm | 2.4 μm |
| quantity of | 40% | | Comp. Ex. 2 | |
| cyclodextrin | | | (bitterness | |
| addition | | | ∘, flavor | |
| | | | x) | |
| | 20% | Comp. Ex. 1 | Example 1 | |
| | | (bitterness | (bitterness | |
| | | x, flavor | ∘, flavor | |
| | | ∘) | ∘) | |
| | 2% | | | Example 3 |
| | | | | (bitterness |
| | | | | ∘, flavor |
| | | | | ∘) |
| | | | | Example 4 |
| | | | | (bitterness |
| | | | | ∘, flavor |
| | | | | ∘) |
| | 0.5% | | Example 2 | |
| | | | (bitterness | |
| | | | ∘, flavor | |
| | | | ∘) | |
| | 0.1% | | Comp. Ex. 3 | |
| | | | (bitterness | |
| | | | x, flavor | |
| | | | ∘) | |

A comparison of Example 1 and Comparative Example 1 demonstrates that the average particle size of the cyclodextrin must be brought to less than or equal to 30 μm in order to mask the bitter taste inherent in a Stevia-derived sweet substance with a small amount of cyclodextrin.

A comparison of Example 2 and Comparative Example 3 demonstrates that, in order for the pulverized cyclodextrin to manifest a bitter taste-masking activity, the amount of pulverized cyclodextrin addition must be made at least 0.5 mass % with respect to the mass of the Stevia-derived sweet substance.

A comparison of Example 1 and Comparative Example 2 demonstrates that, in order to prevent a degradation of the coffee flavor by the inclusion activity of the cyclodextrin, the amount of the cyclodextrin addition must be made less than or equal to 20 mass % with respect to the mass of the Stevia-derived sweet substance.

The preceding demonstrates that, in order to mask the bitter taste inherent in a Stevia-derived sweet substance while at the same time restraining the amount of cyclodextrin addition, cyclodextrin with a particle size of less than or equal to 30 μm must be blended with the Stevia-derived sweet substance at from 0.5 to 20 mass % of the cyclodextrin with respect to the mass of the Stevia-derived sweet substance.

Industrial Applicability

The present invention can be used as a sugar-substitute sweetener.

What is claimed is:

1. A sweetener containing a Stevia-derived sweet substance, comprising:
a Stevia-derived sweet substance; and
from 0.5 to 20 mass %, with respect to the mass of the Stevia-derived sweet substance, cyclodextrin with an average particle size of less than or equal to 30 μm.

2. The sweetener according to claim 1, wherein the particle size of the cyclodextrin is less than or equal to 10 μm.

3. The sweetener according to claim 1, wherein the particle size of the cyclodextrin is less than or equal to 5 μm.

4. The sweetener according to claim 1, comprising 0.5 to 10 mass % cyclodextrin with respect to the mass of the Stevia-derived sweet substance.

5. The sweetener according to claim 1, comprising 0.5 to 5 mass % cyclodextrin with respect to the mass of the Stevia-derived sweet substance.

6. The sweetener according to claim 1, comprising 0.5 to 10 mass %, with respect to the mass of the Stevia-derived sweet substance, cyclodextrin with an average particle size of less than or equal to 10 μm.

7. The sweetener according to claim 1, comprising 0.5 to 5 mass %, with respect to the mass of the Stevia-derived sweet substance, cyclodextrin with an average particle size of less than or equal to 5 μm.

8. The sweetener according to claim 1, wherein the Stevia-derived sweet substance is a Stevia-derived sweet substance that has been subjected to an enzymatic treatment.

9. The sweetener according to claim 1, wherein the Stevia-derived sweet substance is rebaudioside A.

10. The sweetener according to claim 1, further comprising a sweet substance other than the Stevia-derived sweet substance.

11. A method of producing a sweetener that contains a Stevia-derived sweet substance, comprising the step of:
mixing a Stevia-derived sweet substance with from 0.5 to 20 mass %, with respect to the mass of the Stevia-derived sweet substance, cyclodextrin with an average particle size of less than or equal to 30 μm.

12. A method of producing a sweetener that contains a Stevia-derived sweet substance, comprising the steps of:
kneading a Stevia-derived sweet substance with from 0.5 to 20 mass %, with respect to the mass of the Stevia-derived sweet substance, of cyclodextrin with an average particle size of less than or equal to 30 μm, in the presence of wetting agent; and
drying the resulting mixture.

13. The method according to claim 12, wherein the wetting agent is water and/or ethanol.
